(19) United States
(12) Patent Application Publication
(10) Pub. No.: US 2010/0182932 A1
(43) Pub. Date: Jul. 22, 2010

(54) Apparatus, Method and Computer Program Product Providing Group Resource Allocation for Reducing Signaling Overhead

(76) Inventors: Shashikant Maheshwarl, Irving, TX (US); Xin Qi, Beijing (CN); Xiao Yi Wang, Beijing (CN)

Correspondence Address: HARRINGTON & SMITH, 4 RESEARCH DRIVE, Suite 202, SHELTON, CT, 06484-6212, US

(21) Appl. No.: 12/669,831

(22) PCT Filed: Jul. 24, 2008
(86) PCT No.: PCT/US08/09052

§ 371 Date: Mar. 19, 2010

Related U.S. Application Data
(60) Provisional application No. 60/961,951, filed on Jul. 24, 2007.

(51) Int. Cl. H04L 12/28

(52) U.S. Cl. 370/254

(57) ABSTRACT

Exemplary embodiments of this invention provide a reduction in signaling overhead by allocating radio resources to subscriber stations (SSs) based on a group of connection identifiers (CIDs), where the group corresponds to a plurality of connections. The use of these exemplary embodiments can be particularly beneficial for certain applications, such as voice over internet protocol (VoIP) applications, by removing unnecessary signaling overhead. In one exemplary embodiment of the invention, a method includes: receiving signaling that assigns a subscriber station to a particular group of subscriber stations or that removes an already assigned subscriber station from the particular group of subscriber stations; and transmitting an acknowledgment that confirms receipt of the signaling.

### TECHNICAL FIELD

The exemplary and non-limiting embodiments of this invention relate generally to wireless communication systems, methods, devices and computer programs stored in data storage medium and, more specifically, relate to techniques for sending information to a group of receiving devices.

### BACKGROUND

Various abbreviations that appear in the specification and/or in the drawing figures are defined as follows:

ACK acknowledgement
AP access point
BS base station
BWA broadband wireless access
CID connection identifier
DL downlink (BS to SS)
FTP file transfer protocol
GMH generic MAC header
HARQ hybrid automatic repeat request
IE information element
MAC medium access control (layer 2, L2)

### MPDU MAC PDU

NACK negative acknowledgement
OFDMA orthogonal frequency division multiple access
PDU protocol data unit
PHY physical layer (layer 1, L1)
QoS quality of service
RS relay station
SS subscriber station
TLV type/length/value
UL uplink (SS to BS)
VoIP voice over interne protocol
WiMAX worldwide interoperability for microwave access (IEEE 802.16 standard)

An IEEE 802.16 working group has been established (802.16m) to provide an advanced air interface which amends IEEE standards IEEE 802.16-2004, “IEEE Standard for Local and Metropolitan Area Networks—Part 16: Air Interface for Fixed Broadband Wireless Access Systems,” Jun. 24, 2004, and IEEE 802.16e-2005, “IEEE Standard for Local and Metropolitan Area Networks—Part 16: Air Interface for Fixed and Mobile Broadband Wireless Access Systems” February, 2006 (which may be collectively referred to herein as 802.16), in order to meet the requirements of next generation mobile networks.

These IEEE 802.16 standards were designed to support fixed, nomadic and mobile clients in a BWA network. These standards provide different scheduling services to satisfy the demands for various multimedia services. Each type of service is identified by its QoS requirements. The 802.16 MAC is the central control of these standards to provide the necessary QoS support. The principal mechanism for providing QoS is to associate packets traversing the MAC interface into a service flow identified by a CID. A service flow is a unidirectional flow of packets that is provided or associated with a particular QoS. The SS and BS provide this QoS according to a QoS Parameter Set defined for the service flow.

The bandwidth allocation mechanism is an important element to provide the needed QoS support. For the DL, bandwidth allocation is performed completely by the BS using a DL-MAP message. For the UL, the BS uses the UL-MAP message to allocate bandwidth to a SS as a whole based on bandwidth requests made by the SS. The SS then schedules the transmission of its various active service flows within the allocated bandwidth.

Typical scheduling services supported by 802.16 include: real-time data streams consisting of fixed-size data packets issued at periodic intervals (such as VoIP without silence suppression and T1/E1); real-time data streams consisting of variable-sized data packets that are issued at periodic intervals, (such as MPEG video); delay-tolerant data streams consisting of variable-sized data packets for which a minimum data rate is required (such as FTP); and best-effort data streams.

Although the 802.16 standard provides support for VoIP, the transmission of VoIP packets has a low efficiency due to the large signaling overhead involved in the DL-MAP/UL-MAP and MAC messages. Furthermore, in an IEEE 802 meeting of March 2007, a draft document (Draft IEEE 802.16m Requirements, [online] http://www.ieee802.org/16/tgm/docs/80216m-07_{—}002r1.pdf) was formed for 802.16m, where the improvement of VoIP is emphasized to be a performance metric.

The low efficiency of the signaling mechanism in 802.16e has been generally known for some time. The MAP message is a particularly inefficient part of the signaling mechanism. Although some optimization has been attempted, normally, for the HARQ burst, a 2-byte CID should be included in the associated DL-MAP-IE, and another four bytes would be used in the DL-MAP-IE, to describe the location of the PHY burst in the OFDMA frame. Not discussed herein is the repetition code for MAP messages.

When considering certain traffic with consistent and small packet arrivals, such as VoIP, the need for frequent resource allocation can require a large number of MAP messages, particularly when there are a large number of VoIP users, and these DL and UL MAP messages would all require that the MAP_IE include the 2-byte CID and the 4-bytes of burst information. Clearly, the current approach can result in an excessive amount of signaling overhead, thereby significantly reducing the radio link efficiency.

In 802.16e there is support to map several MAC packets from different connections to one burst. However, this approach does not appreciably reduce the signaling overhead since the CIDs for all of the users are included in a MAP message for every frame.

### SUMMARY

The below summary section is intended to be merely exemplary and non-limiting.

In one exemplary embodiment of the invention, a method comprising: receiving signaling that assigns a subscriber station to a particular group of subscriber stations or that removes an already assigned subscriber station from the particular group of subscriber stations; and transmitting an acknowledgment that confirms receipt of the signaling.

In another exemplary embodiment of the invention, an apparatus comprising: means for receiving signaling that assigns a subscriber station to a particular group of subscriber stations or that removes an already assigned subscriber station from the particular group of subscriber stations; and means for transmitting an acknowledgment that confirms receipt of the signaling.

In another exemplary embodiment of the invention, a program storage device readable by a machine, tangibly embodying a program of instructions executable by the machine for performing operations, said operations comprising: receiving signaling that assigns a subscriber station to a particular group of subscriber stations or that removes an already assigned subscriber station from the particular group of subscriber stations; and transmitting an acknowledgment that confirms receipt of the signaling.

In another exemplary embodiment of the invention, an apparatus comprising: a receiver configured to receive signaling that assigns a subscriber station to a particular group of subscriber stations or that removes an already assigned subscriber station from the particular group of subscriber stations; and a transmitter configured to transmit an acknowledgment that confirms receipt of the signaling.

In another exemplary embodiment of the invention, a method comprising: transmitting signaling towards a subscriber station, said signaling configured to assign the subscriber station to a particular group of subscriber stations or to remove an already assigned subscriber station from the particular group of subscriber stations; and receiving an acknowledgment from the subscriber station that confirms receipt of the signaling.

In another exemplary embodiment of the invention, an apparatus comprising: means for transmitting signaling towards a subscriber station, said signaling configured to assign the subscriber station to a particular group of subscriber stations or to remove an already assigned subscriber station from the particular group of subscriber stations; and means for receiving an acknowledgment from the subscriber station that confirms receipt of the signaling.

In another exemplary embodiment of the invention, a program storage device readable by a machine, tangibly embodying a program of instructions executable by the machine for performing operations, said operations comprising: transmitting signaling towards a subscriber station, said signaling configured to assign the subscriber station to a particular group of subscriber stations or to remove an already assigned subscriber station from the particular group of subscriber stations; and receiving an acknowledgment from the subscriber station that confirms receipt of the signaling.

In another exemplary embodiment of the invention, an apparatus comprising: a transmitter configured to transmit signaling towards a subscriber station, said signaling configured to assign the subscriber station to a particular group of subscriber stations or to remove an already assigned subscriber station from the particular group of subscriber stations; and a receiver configured to receive an acknowledgment from the subscriber station that confirms receipt of the signaling.

### BRIEF DESCRIPTION OF THE DRAWINGS

The foregoing and other aspects of exemplary embodiments of this invention are made more evident in the following Detailed Description, when read in conjunction with the attached Drawing Figures, wherein:

FIG. 1 shows a simplified block diagram of various exemplary electronic devices that are suitable for use in practicing the exemplary embodiments of this invention;

FIG. 2 shows a non-limiting example of an extended DL_MAP_IE in accordance with the exemplary embodiments of this invention;

FIG. 3 shows a non-limiting example of a Group_ID IE in accordance with the exemplary embodiments of this invention;

FIG. 4 is a logic flow diagram that illustrates an exemplary method, as well as aspects of the operation of a computer program, by the access node or base station shown in FIG. 1; and

FIG. 5 is a logic flow diagram that illustrates an exemplary method, as well as aspects of the operation of a computer program, by the subscriber station shown in FIG. 1.

### DETAILED DESCRIPTION

By way of introduction, it is noted that in one aspect thereof the use of the exemplary embodiments of this invention provides a significant improvement of at least VoIP support in 802.16 by removing unnecessary signaling overhead, thereby facilitating the development of 802.16m and other standards. The exemplary embodiments may provide a significant improvement gain by grouping together two or more CIDs for corresponding ones of two or more SSs. That is, the use of the exemplary embodiments of this invention provides a significant reduction in signaling overhead by allocating radio resources to SSs based on a group of CIDs, where the group corresponds to a plurality of connections. The use of these exemplary embodiments can be particularly beneficial for certain applications, such as VoIP applications, by removing unnecessary signaling overhead.

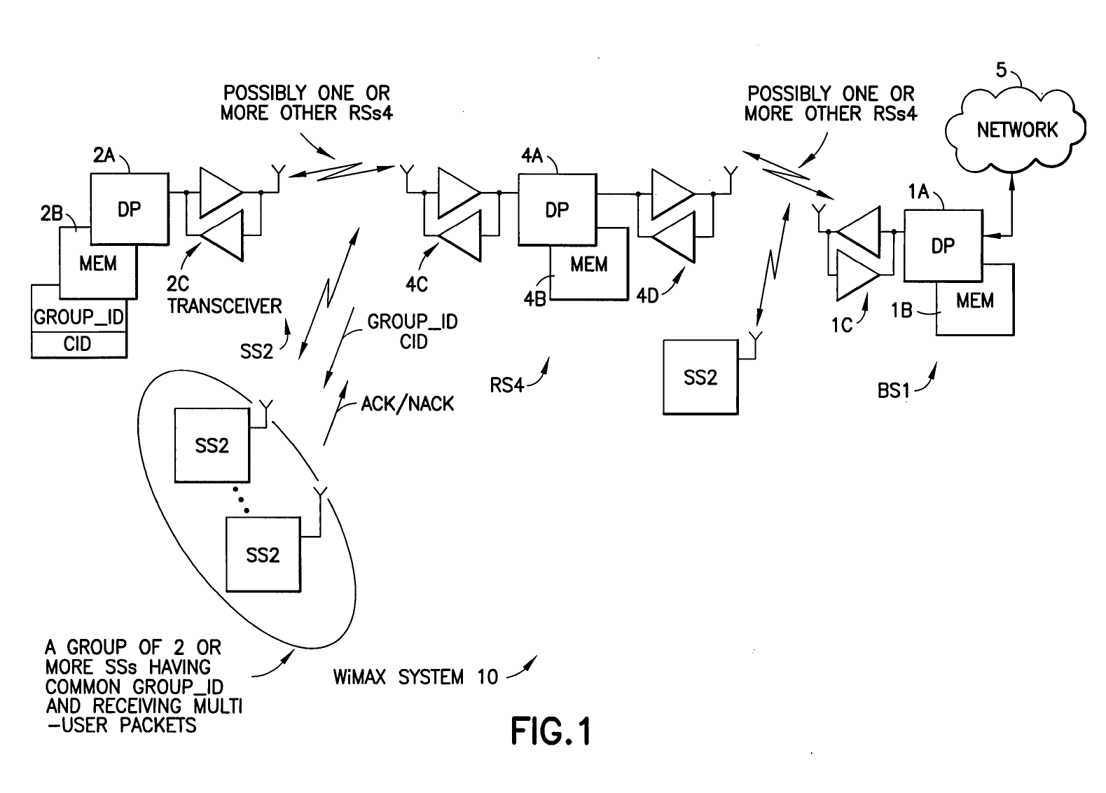

Reference is made to FIG. 1 for illustrating a simplified block diagram of various exemplary electronic devices that are suitable for use in practicing the exemplary embodiments of this invention. In FIG. 1, a WiMAX network or system 10 includes at least one BS (or AP) 1, a plurality of SSs 2, and possibly one or more (optional) relay stations (RSs) 4 (for example, in a multi-hop type of WiMAX environment). The SS 2 and BS 1 each include a suitable controller, such as at least one data processor (DP) 2A, 1A, operatively coupled with a memory (MEM) 2B, 1B, respectively. Each of the SS 2 and BS 1 includes at least one wireless (e.g., radio frequency RF) transceiver 2C, 1C, respectively. The at least one RS 4 (if present) is assumed to be similarly constructed, and may include a DP 4A and associated MEM 4B, and is adapted for communication with the SS 2 and the BS 1 with at least one or two, as shown, wireless transceivers 4C, 4D. Note that the RS 4 may be coupled directly to the SS 2, or indirectly coupled via one or more other RSs 4, and may be coupled directly to the BS 1, or indirectly coupled via one or more other RSs 4. Note further that the presence of one or more RSs 4 is completely optional, as some of the exemplary embodiments of this invention may need only a single BS 1 and two or more of the SSs 2 to be fully operational.

It can be noted in FIG. 1 that at least two of the SSs 2 are shown grouped together having a common Group_ID and receiving multi-user packets, in accordance with the exemplary embodiments of this invention.

At least the memories 2B and 1B are assumed to include program instructions, executable by the associated DPs 2A and 1A, respectively, for operation in accordance with the exemplary embodiments of this invention, as described in further detail below.

In general, the exemplary embodiments of this invention may be implemented at least in part by computer software executable by the DPs 2A and 1A, or by hardware, or by a combination of software and hardware.

In general, the various embodiments of the SS 2 can include, but are not limited to, cellular telephones, personal digital assistants (PDAs) having wireless communication capabilities, portable and desktop computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions. Note that the SS 2 may be a mobile device, or a device intended to be used in one location (e.g., a PC), as non-limiting examples.

The memories 2B, 1B and 4B may be of any type suitable to the local technical environment and may be implemented using any suitable data storage technology, such as semiconductor-based memory devices, flash memory, magnetic memory devices and systems, optical memory devices and systems, fixed memory and removable memory, as non-limiting examples. The DPs 2A, 1A and 4A may be of any type suitable to the local technical environment, and may include one or more of general purpose computers, special purpose computers, microprocessors, digital signal processors (DSPs) and processors based on a multi-core processor architecture, as non-limiting examples.

Of particular interest to the ensuing discussion of the exemplary embodiments of this invention is IEEE 802.16e-2005, “IEEE Standard for Local and Metropolitan Area Networks—Part 16: Air Interface for Fixed and Mobile Broadband Wireless Access Systems” February, 2006, Section 8.4.5.3, DL-MAP IE format.

In accordance with the exemplary embodiments of this invention, resource allocation is based on a group of CIDs. The group corresponds to several connections (to several SSs 2). This implies that packets for a plurality of SSs 2 (two or more SSs 2) may be mapped in one physical burst in the DL. In this case, each related SS 2 (each member of the CID group) decodes the DL physical burst to determine whether there is a packet or packets intended for it. The SS 2 is operable to remember to which CID group it is assigned, such as by storing the assigned CID in the memory 2B. In some exemplary embodiments, the CID of a particular SS 2 need appear only in a group_MAP_IE for the purpose of adding or deleting CIDs from a particular group.

Describing now these exemplary embodiments in further detail, the concept of a “group” is established for indicating a group of CIDs. A group may be identified by (as a non-limiting example) an 8-bit Group_ID, and a Group_MAP_IE (a new, extended DL MAP IE) used for indicating the addition and/or deletion of CIDs for the corresponding group.

In other exemplary embodiments, the number of bits used for the Group_ID may be flexibly configurable.

The Group_MAP_IE may be used to indicate one or several bursts for one group.

The SS 2 preferably sends a confirmation back to the BS 1 after it receives a Group_MAP_IE that adds or deletes the CID of the SS to or from a group. The SS 2 is expected to retain the Group_ID that is assigned to it, since the group resource allocation is indicated by the Group_ID as opposed to the CID (as in the DL_MAP_IE).

In operation, the BS 1 concatenates MAC packets for a plurality (at least two) of CIDs within the group to those physical bursts indicated by the Group_MAP_IE.

Those SSs 2 in a group decode the burst, indicated by the Group_MAP_IE, having the corresponding Group_ID.

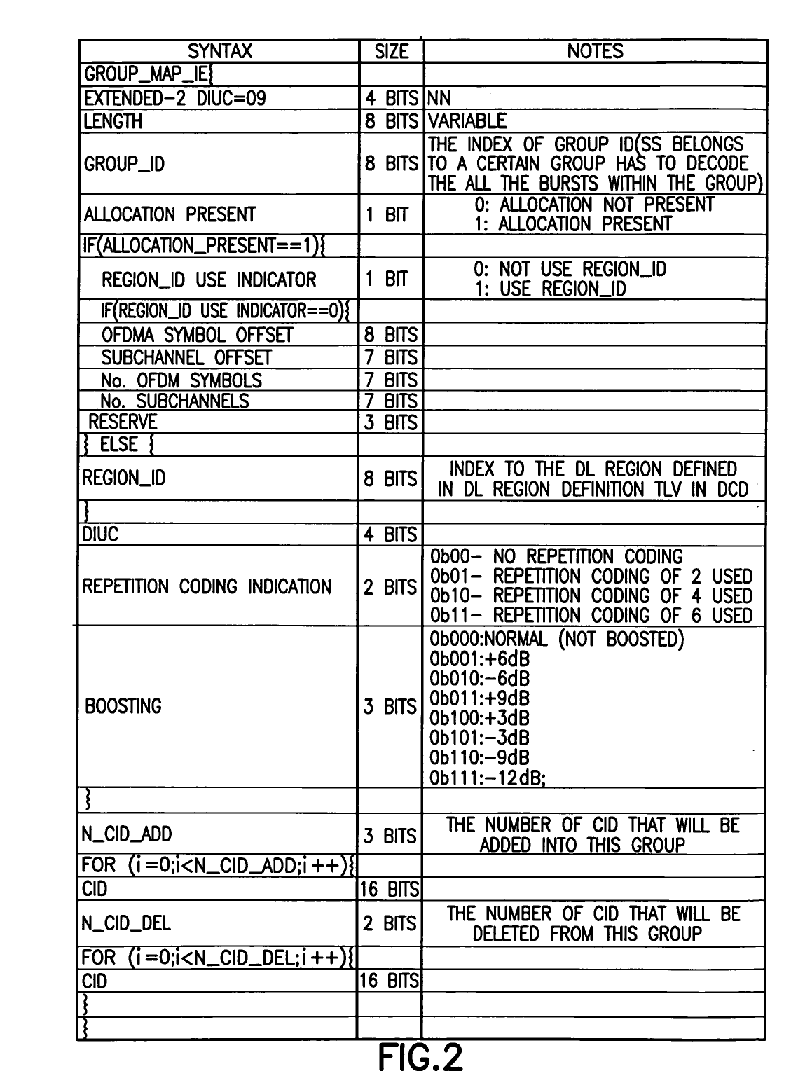

Reference can be made to FIG. 2 for showing a non-limiting example of an extended DL_MAP_IE (e.g., a Group_MAP_IE) in accordance with the exemplary embodiments of this invention. Of particular interest to this invention is the Group_id IE, which specifies a particular CID group, and the N_CID_Add and N_CID_del IEs that indicate a CID number to be added to the specified group or deleted from the specified group, respectively.

In order to maintain signaling efficiency, one half of an UL OFDM slot (e.g., similar to that presently specified for a HARQ UL ACK channel) may be used by the SS 2 to send a confirmation (e.g., an ACK/NAK) of its receipt of the Group_MAP_IE, such as the one shown in FIG. 2. The encoding of the ACK/NAK may be similar to currently defined HARQ ACK/NAK encoding.

HARQ-related ACK/NACK signaling is defined in 802.16e in Section 8.4.5.3.21 and 8.4.5.4.13, “UL ACK Channel.”

There are several possible exemplary embodiments for sending the Group_MAP_IE confirmation by the SS 2. Such exemplary embodiments include the following:

Embodiment A: The BS 1 allocates a Group-ACK Region, which may be similar to a HARQ_ACK_Allocation region, where the SS 2 can send the confirmation (ACK/NAK). In this case, the SS 2 sends the confirmation (ACK/NAK) in a one half slot channel according to the order in which the CID appears in the Group_MAP_IE.
Embodiment B: The SS 2 may use a feedback channel in the HARQ_ACK_Allocation region to send a confirmation (ACK/NACK) to the BS 1 concerning receipt of the group allocation signaling. In this case, the SS 2 may send the confirmation (ACK/NAK) in a one half slot channel according to the order in which the CID appears in the Group_MAP_IE, and after the last HARQ_ACK_Feedback channel.
Embodiment C: The SS 2 may employ a newly-defined MAC message to confirm to the BS 1 that the Group_Map_IE has been received. This newly defined MAC message preferably includes the Group_ID (the CID is already included in the GMH). The GMH contains the details of the MPDU. Principally, the GMH includes: the CID that defines the connection that the packet is servicing, the length of the frame and bits to qualify the presence of the CRC and sub headers.
Embodiment D: The SS 2 may employ a special indicator in the MAC header, or in a sub-header, to confirm to the BS 1 that the Group_Map_IE has been received.

It should be noted that in some exemplary embodiments, the SS 2 may follow the same feedback delay as the already-specified HARQ-ACK_delay-offset. For example, if the Group_MAP_IE is sent in frame N, then the ACK/NAK can be sent in frame N+HARQ_DL_ACK-delay.

In at least some exemplary embodiments of this invention, the 2 bytes of the CID for each of several SSs 2 are replaced by one 8-bit Group_ID using the Group_ID IE (for example, with the extended-2 DIUC shown in FIG. 2) for resource allocations. For example, a group may contain 15 CIDs. In the conventional approach there are at least 2*15 bytes of CID signaling included in every frame. As can be appreciated, using aspects of the exemplary embodiments of the invention, a significant reduction in signaling overhead can be obtained.

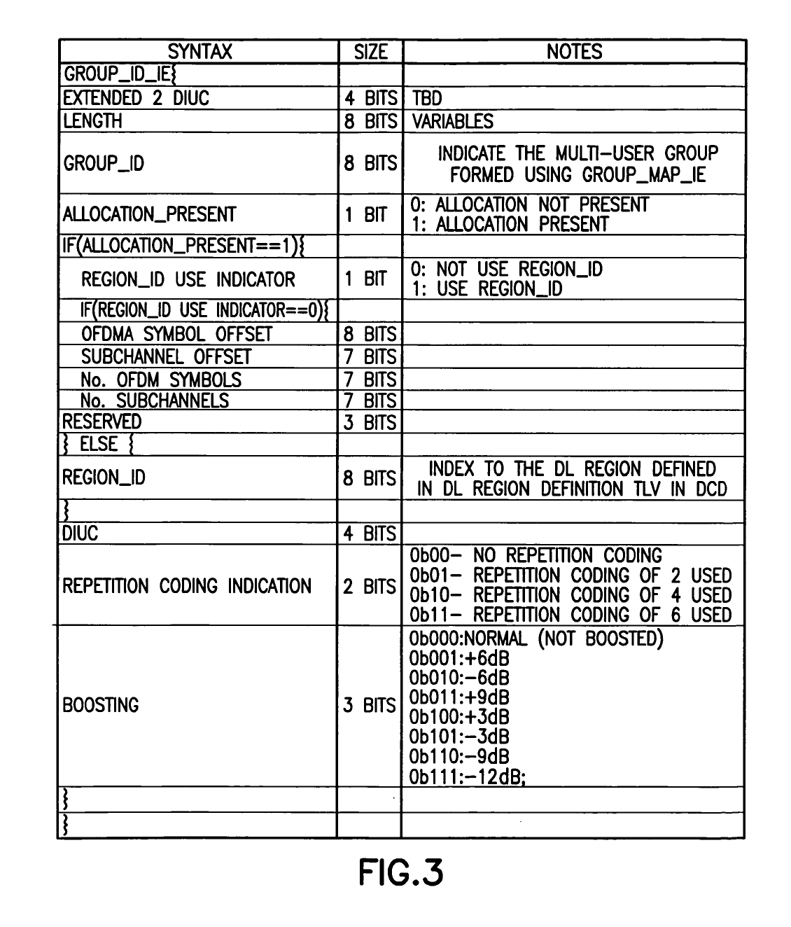

One exemplary embodiment of the Group_ID IE is shown in FIG. 3.

In another exemplary embodiment, the Group_ID may be 16-bits in length, which is of similar length to the CID. With this exemplary embodiment, the Group_ID may replace the CID in the MAP-IE (e.g., DL-MAP (IEs), HARQ-MAP IEs, etc.) to indicate the allocation of the PHY burst. In this case, the Group_ID IE (extended-2 DIUC) need not be used.

Within the new group allocation, the CIDs need not be repeated in every frame. Instead, the CID need only appear at the beginning for adding, or at the end for deleting, or possibly for one or more other special cases.

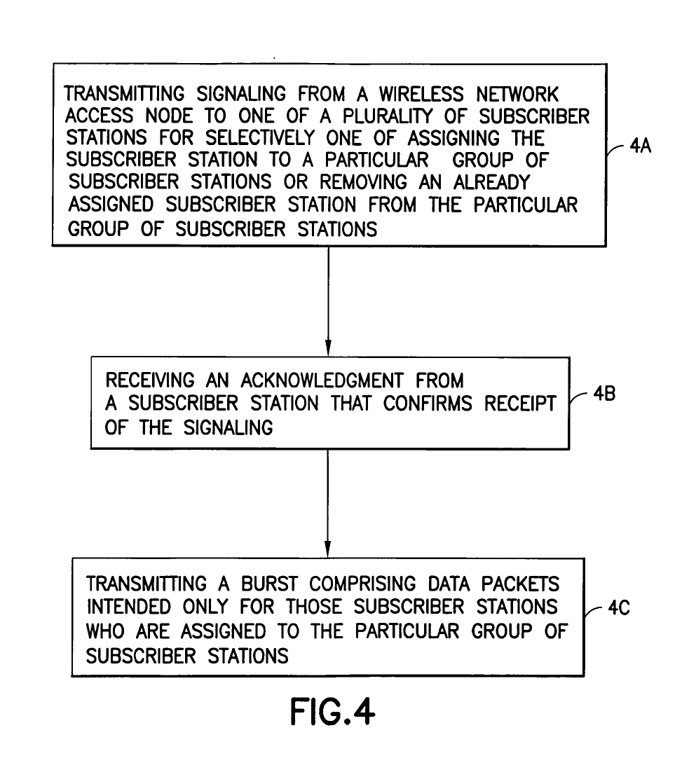

Based on the foregoing it should be apparent that the exemplary embodiments of this invention provide a method (see also FIG. 4) that comprises:

4A. transmitting signaling from a wireless network access node to one of a plurality of subscriber stations for selectively one of assigning the subscriber station to a particular group of subscriber stations or removing an already assigned subscriber station from the particular group of subscriber stations; and
4B. receiving an acknowledgment from a subscriber station that confirms receipt of the signaling.

Further exemplary embodiments of the invention may comprise one or more of the following.

The method as in any of the preceding paragraphs, further comprising:

4C. transmitting a burst comprising data packets intended only for those subscriber stations who are assigned to the particular group of subscriber stations.

The method as in any of the preceding paragraphs, where an acknowledgment is received from one of an allocated Group-ACK region in a one half slot channel; or is received in a feedback channel of a HARQ_ACK Allocation region; or is received in a MAC message that includes an identification of the group; or is received as part of a MAC header or sub-header, as non-limiting examples.

The method as in any of the preceding paragraphs, where the acknowledgment is received in a frame following a predetermined delay from the frame in which the signaling was transmitted.

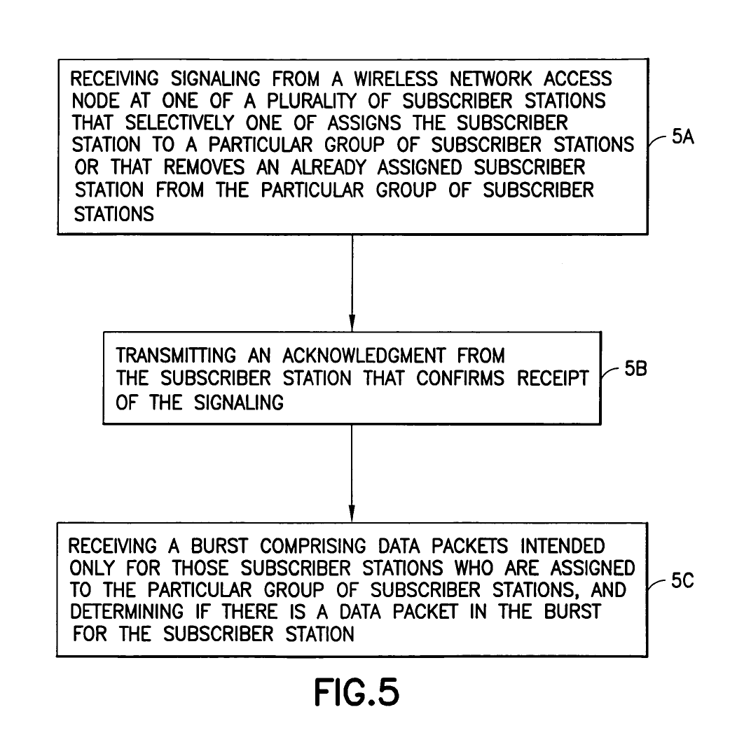

Based on the foregoing it should be apparent that the exemplary embodiments of this invention provide a further method (see also FIG. 5) that comprises:

5A. receiving signaling from a wireless network access node at one of a plurality of subscriber stations that selectively one of assigns the subscriber station to a particular group of subscriber stations or that removes an already assigned subscriber station from the particular group of subscriber stations; and
5B. transmitting an acknowledgment from the subscriber station that confirms receipt of the signaling.

Further exemplary embodiments of the invention may comprise one or more of the following.

The method as in any of the preceding paragraphs, further comprising:

5C. receiving a burst comprising data packets intended only for those subscriber stations who are assigned to the particular group of subscriber stations, and determining if there is a data packet in the burst for the subscriber station.

The method as in any of the preceding paragraphs, where acknowledgment is transmitted using one of an allocated Group-ACK region in a one half slot channel; or in a feedback channel of a HARQ_ACK Allocation region; or in a MAC message that includes an identification of the group; or in part of a MAC header or sub-header, as non-limiting examples.

The method as in any of the preceding paragraphs, where the acknowledgment is transmitted in a frame following a predetermined delay from the frame in which the signaling was received.

It is pointed out that the procedures shown in FIGS. 4 and 5 need not be accomplished in each frame, but instead can be performed only when the BS 1 desires to add or delete a certain SS 2 (i.e., a certain CID) from a particular group.

In general, the BS 1 may desire to group together those SSs 2 having a similar radio environment, although other criteria may be considered.

As a non-limiting example, for the case of a handover, when the SS 2 is currently assigned to a particular group, it may be a default operation (for both the BS 1 and the SS 2) to automatically remove the SS2 from the particular group. In this manner no explicit signaling need be sent.

The various blocks shown in FIGS. 4 and 5 may be viewed as method steps, and/or as operations that result from operation of computer program code that is stored in a computer readable medium, such as one of the memories 1B, 2B shown in FIG. 1, and/or as a plurality of coupled logic circuit elements constructed to carry out the associated function(s) and, for example, embodied within at least one integrated circuit.

Based on the foregoing description it should further be apparent that the exemplary embodiments of this invention also provide a wireless network access node that comprises a transmitter configured to transmit signaling to one of a plurality of subscriber stations for selectively one of assigning the subscriber station to a particular group of subscriber stations or removing an already assigned subscriber station from the particular group of subscriber stations; and further configured to transmit a burst comprising data packets intended only for those subscriber stations who are assigned to the particular group of subscriber stations. The wireless access node is also comprised of a receiver that is configured to receive an acknowledgment from a subscriber station that confirms receipt of the signaling.

The acknowledgment may be received from one of an allocated Group-ACK region in a one half slot channel; or from a feedback channel of a HARQ_ACK_Allocation region; or from a MAC message that includes an identification of the group; or as part of a MAC header or sub-header, as non-limiting examples. The acknowledgment may be received in a frame following a predetermined delay from the frame in which the signaling was transmitted.

Based on the foregoing description it should be further apparent that the exemplary embodiments of this invention also provide a subscriber station comprising a receiver that is configured to receive signaling from a wireless network access node that selectively one of assigns the subscriber station to a particular group of subscriber stations or that removes an already assigned subscriber station from the particular group of subscriber stations; and where the receiver is further configured to receive a burst comprising data packets intended only for those subscriber stations who are assigned to the particular group of subscriber stations. The subscriber station further includes a processor adapted to determine if there is a data packet in the burst for the subscriber station. The subscriber station further includes a transmitter configured to transmit an acknowledgment to the network access node confirming receipt of the signaling.

The acknowledgment may be transmitted using one of an allocated Group-ACK region in a one half slot channel; or in a feedback channel of a HARQ_ACK_Allocation region; or in a MAC message that includes an identification of the group; or in part of a MAC header or sub-header, as non-limiting examples. The acknowledgment may transmitted in a frame following a predetermined delay from the frame in which the signaling was received.

Below are provided further descriptions of non-limiting, exemplary embodiments. The below-described exemplary embodiments are separately numbered for clarity and identification. This numbering should not be construed as wholly separating the below descriptions since various aspects of one or more exemplary embodiments may be practiced in conjunction with one or more other aspects or exemplary embodiments.

(1) A method comprising: receiving signaling that assigns a subscriber station to a particular group of subscriber stations or that removes an already assigned subscriber station from the particular group of subscriber stations; and transmitting an acknowledgment that confirms receipt of the signaling.

A method as above, further comprising: receiving a burst comprising at least one data packet for at least one subscriber station of the particular group of subscriber stations, where the at least one data packet is not for a subscriber station that is not assigned to the particular group of subscriber stations; and determining if there is a data packet in the burst for a certain subscriber station of the particular group of subscriber stations.

A method as in any above, where the acknowledgment is transmitted using one of: an allocated group acknowledgement region in a one half slot channel, a feedback channel of a hybrid automatic repeat request acknowledgement allocation region, a medium access control (MAC) message that includes an identification of the group, or at least a portion of a MAC header or a MAC sub-header. A method as in any above, where the acknowledgment is transmitted in a frame following a predetermined delay from a frame in which the signaling was received. A method as in any above, where the method is implemented by a mobile station, a mobile device, a mobile node, a subscriber station, a portable computer, a mobile phone or a cellular phone. A method as in any above, where the method is implemented within a wireless communication system or network. A method as in any above, where the method is implemented within a WiMAX communication system or network.

A method as in any above, where the method is implemented by a computer program. A method as in any above, where the method is implemented by a computer program comprising program instructions stored on a computer-readable medium. A method as in any above, where the method is implemented by a computer program comprising program instructions stored on a program storage device.

(2) A program storage device readable by a machine, tangibly embodying a program of instructions executable by the machine for performing operations, said operations comprising: receiving signaling that assigns a subscriber station to a particular group of subscriber stations or that removes an already assigned subscriber station from the particular group of subscriber stations; and transmitting an acknowledgment that confirms receipt of the signaling.

(3) An apparatus comprising: means for receiving signaling that assigns a subscriber station to a particular group of subscriber stations or that removes an already assigned subscriber station from the particular group of subscriber stations; and means for transmitting an acknowledgment that confirms receipt of the signaling.

An apparatus as above, further comprising: means for receiving a burst comprising at least one data packet for at least one subscriber station of the particular group of subscriber stations, where the at least one data packet is not for a subscriber station that is not assigned to the particular group of subscriber stations; and means for determining if there is a data packet in the burst for a certain subscriber station of the particular group of subscriber stations.

An apparatus as in any above, where the acknowledgment is transmitted by the means for transmitting using one of: an allocated group acknowledgement region in a one half slot channel, a feedback channel of a hybrid automatic repeat request acknowledgement allocation region, a medium access control (MAC) message that includes an identification of the group, or at least a portion of a MAC header or a MAC sub-header. An apparatus as in any above, where the acknowledgment is transmitted by the means for transmitting in a frame following a predetermined delay from a frame in which the signaling was received.

An apparatus as in any above, where the apparatus comprises a mobile station, a mobile device, a mobile node, a subscriber station, a portable computer, a mobile phone or a cellular phone. An apparatus as in any above, where the apparatus comprises a node of a wireless communication system or network. An apparatus as in any above, where the apparatus comprises a node of a WiMAX communication system or network.

An apparatus as in any above, where the means for receiving comprises at least one receiver and the means for transmitting comprises at least one transmitter. An apparatus as in any above, further comprising means for processing and/or means for storing. An apparatus as in any above, where the means for processing comprises at least one processor and/or the means for storing comprises at least one memory. An apparatus as in any above, where the means for determining comprises at least one processor. An apparatus as in any above, embodied in at least one integrated circuit.

(4) An apparatus comprising: a receiver configured to receive signaling that assigns a subscriber station to a particular group of subscriber stations or that removes an already assigned subscriber station from the particular group of subscriber stations; and a transmitter configured to transmit an acknowledgment that confirms receipt of the signaling.

(5) An apparatus comprising: reception circuitry configured to receive signaling that assigns a subscriber station to a particular group of subscriber stations or that removes an already assigned subscriber station from the particular group of subscriber stations; and transmission circuitry configured to transmit an acknowledgment that confirms receipt of the signaling. An apparatus as in any above, embodied in at least one integrated circuit.

(6) A method comprising: transmitting signaling towards a subscriber station, said signaling configured to assign the subscriber station to a particular group of subscriber stations or to remove an already assigned subscriber station from the particular group of subscriber stations; and receiving an acknowledgment from the subscriber station that confirms receipt of the signaling.

A method as above, further comprising: transmitting a burst comprising at least one data packet for at least one subscriber station of the particular group of subscriber stations, where the at least one data packet is not for a subscriber station that is not assigned to the particular group of subscriber stations.

A method as in any above, where the acknowledgment is received using one of: an allocated group acknowledgement region in a one half slot channel, a feedback channel of a hybrid automatic repeat request acknowledgement allocation region, a medium access control (MAC) message that includes an identification of the group, or at least a portion of a MAC header or a MAC sub-header. A method as in any above, where the acknowledgment is received in a frame following a predetermined delay from a frame in which the signaling was transmitted.

A method as in any above, where the method is implemented by an access node or a base station. A method as in any above, where the method is implemented within a wireless communication system or network. A method as in any above, where the method is implemented within a WiMAX communication system or network.

A method as in any above, where the method is implemented by a computer program. A method as in any above, where the method is implemented by a computer program comprising program instructions stored on a computer-readable medium. A method as in any above, where the method is implemented by a computer program comprising program instructions stored on a program storage device.

(7) A program storage device readable by a machine, tangibly embodying a program of instructions executable by the machine for performing operations, said operations comprising: transmitting signaling towards a subscriber station, said signaling configured to assign the subscriber station to a particular group of subscriber stations or to remove an already assigned subscriber station from the particular group of subscriber stations; and receiving an acknowledgment from the subscriber station that confirms receipt of the signaling.

(8) An apparatus comprising: means for transmitting signaling towards a subscriber station, said signaling configured to assign the subscriber station to a particular group of subscriber stations or to remove an already assigned subscriber station from the particular group of subscriber stations; and means for receiving an acknowledgment from the subscriber station that confirms receipt of the signaling.

An apparatus as above, further comprising: means for transmitting a burst comprising at least one data packet for at least one subscriber station of the particular group of subscriber stations, where the at least one data packet is not for a subscriber station that is not assigned to the particular group of subscriber stations.

An apparatus as in any above, where the acknowledgment is received by the means for receiving using one of: an allocated group acknowledgement region in a one half slot channel, a feedback channel of a hybrid automatic repeat request acknowledgement allocation region, a medium access control (MAC) message that includes an identification of the group, or at least a portion of a MAC header or a MAC sub-header. An apparatus as in any above, where the acknowledgment is received by the means for receiving in a frame following a predetermined delay from a frame in which the signaling was transmitted.

An apparatus as in any above, where the apparatus comprises an access node or a base station. An apparatus as in any above, where the apparatus comprises a node of a wireless communication system or network. An apparatus as in any above, where the apparatus comprises a node of a WiMAX communication system or network.

An apparatus as in any above, where the means for receiving comprises at least one receiver and the means for transmitting comprises at least one transmitter. An apparatus as in any above, further comprising means for processing and/or means for storing. An apparatus as in any above, where the means for processing comprises at least one processor and/or the means for storing comprises at least one memory. An apparatus as in any above, embodied in at least one integrated circuit.

(9) An apparatus comprising: a transmitter configured to transmit signaling towards a subscriber station, said signaling configured to assign the subscriber station to a particular group of subscriber stations or to remove an already assigned subscriber station from the particular group of subscriber stations; and a receiver configured to receive an acknowledgment from the subscriber station that confirms receipt of the signaling.

(10) An apparatus comprising: transmission circuitry configured to transmit signaling towards a subscriber station, said signaling configured to assign the subscriber station to a particular group of subscriber stations or to remove an already assigned subscriber station from the particular group of subscriber stations; and reception circuitry configured to receive an acknowledgment from the subscriber station that confirms receipt of the signaling. An apparatus as in any above, embodied in at least one integrated circuit.

The exemplary embodiments of the invention, as discussed above and as particularly described with respect to exemplary methods, may be implemented as a computer program product comprising program instructions embodied on a tangible computer-readable medium. Execution of the program instructions results in operations comprising steps of utilizing the exemplary embodiments or steps of the method.

The exemplary embodiments of the invention, as discussed above and as particularly described with respect to exemplary methods, may be implemented in conjunction with a program storage device readable by a machine, tangibly embodying a program of instructions executable by the machine for performing operations. The operations comprise steps of utilizing the exemplary embodiments or steps of the method.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of an IEEE 802.16-type system, it should be appreciated that the exemplary embodiments of this invention are not limited for use with only this one particular type of wireless communication system, and that they may be used to advantage in other communication systems and other wireless communication systems.

Further, it should be appreciated that none of the signaling-related message names, IE names and/or message and IE formats, such as the numbers of elements and arrangement of elements (or the length in bits or bytes of any of the elements), are intended to be limiting with respect to the exemplary embodiments of this invention.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method comprising: receiving signaling that assigns a subscriber station to a particular group of subscriber stations or that removes an already assigned subscriber station from the particular group of subscriber stations; and transmitting an acknowledgment that confirms receipt of the signaling.

2. A method as in claim 1, further comprising: receiving a burst comprising at least one data packet for at least one subscriber station of the particular group of subscriber stations, where the at least one data packet is not for a subscriber station that is not assigned to the particular group of subscriber stations; and determining if there is a data packet in the burst for a certain subscriber station of the particular group of subscriber stations.

3. A method as in claim 1, where the acknowledgment is transmitted using one of: an allocated group acknowledgement region in a one half slot channel, a feedback channel of a hybrid automatic repeat request acknowledgement allocation region, a medium access control (MAC) message that includes an identification of the group, or at least a portion of a MAC header or a MAC sub-header.

4. A method as in claim 1, where the acknowledgment is transmitted in a frame following a predetermined delay from a frame in which the signaling was received.

5. A method as in claim 1, where the method is implemented by a computer program comprising program instructions stored on a computer-readable medium.

6. An apparatus comprising: means for receiving signaling that assigns a subscriber station to a particular group of subscriber stations or that removes an already assigned subscriber station from the particular group of subscriber stations; and means for transmitting an acknowledgment that confirms receipt of the signaling.

7. An apparatus as in claim 6, further comprising: means for receiving a burst comprising at least one data packet for at least one subscriber station of the particular group of subscriber stations, where the at least one data packet is not for a subscriber station that is not assigned to the particular group of subscriber stations; and means for determining if there is a data packet in the burst for a certain subscriber station of the particular group of subscriber stations.

8. An apparatus as in claim 6, where the acknowledgment is transmitted by the means for transmitting using one of: an allocated group acknowledgement region in a one half slot channel, a feedback channel of a hybrid automatic repeat request acknowledgement allocation region, a medium access control (MAC) message that includes an identification of the group, or at least a portion of a MAC header or a MAC sub-header.

9. An apparatus as in claim 6, where the acknowledgment is transmitted by the means for transmitting in a frame following a predetermined delay from a frame in which the signaling was received.

10. An apparatus as in claim 6, where the apparatus comprises a mobile station.

11. A method comprising: transmitting signaling towards a subscriber station, said signaling configured to assign the subscriber station to a particular group of subscriber stations or to remove an already assigned subscriber station from the particular group of subscriber stations; and receiving an acknowledgment from the subscriber station that confirms receipt of the signaling.

12. A method as in claim 11, further comprising: transmitting a burst comprising at least one data packet for at least one subscriber station of the particular group of subscriber stations, where the at least one data packet is not for a subscriber station that is not assigned to the particular group of subscriber stations.

13. A method as in claim 11, where the acknowledgment is received using one of: an allocated group acknowledgement region in a one half slot channel, a feedback channel of a hybrid automatic repeat request acknowledgement allocation region, a medium access control (MAC) message that includes an identification of the group, or at least a portion of a MAC header or a MAC sub-header.

14. A method as in claim 11, where the acknowledgment is received in a frame following a predetermined delay from a frame in which the signaling was transmitted.

15. A method as in claim 11, where the method is implemented by a computer program comprising program instructions stored on a computer-readable medium.

16. An apparatus comprising: means for transmitting signaling towards a subscriber station, said signaling configured to assign the subscriber station to a particular group of subscriber stations or to remove an already assigned subscriber station from the particular group of subscriber stations; and means for receiving an acknowledgment from the subscriber station that confirms receipt of the signaling.

17. An apparatus as in claim 16, further comprising: means for transmitting a burst comprising at least one data packet for at least one subscriber station of the particular group of subscriber stations, where the at least one data packet is not for a subscriber station that is not assigned to the particular group of subscriber stations.

18. An apparatus as in claim 16, where the acknowledgment is received by the means for receiving using one of: an allocated group acknowledgement region in a one half slot channel, a feedback channel of a hybrid automatic repeat request acknowledgement allocation region, a medium access control (MAC) message that includes an identification of the group, or at least a portion of a MAC header or a MAC sub-header.

19. An apparatus as in claim 16, where the acknowledgment is received by the means for receiving in a frame following a predetermined delay from a frame in which the signaling was transmitted.

20. An apparatus as in claim 16, where the apparatus comprises an access node or a base station.
